(19) United States
(12) Patent Application Publication
(10) Pub. No.: US 2012/0313783 A1
(43) Pub. Date: Dec. 13, 2012

(54) Balance alarm sensing arrangement and method thereof

(76) Inventor: Johnson Yang, La Verne, CA (US)

(21) Appl. No.: 13/134,505

(22) Filed: Jun. 8, 2011

(51) Int. Cl. G08B 13/22

(52) U.S. Cl. 340/568.1

(57) ABSTRACT

A balance alarm sensing arrangement for a movable object includes a balance detection module for being supported at the rigid surface of the movable object to detect a stability of the movable object, a deactivating unit for deactivating the balance detection module to allow the movable object being moved, and an alert unit operatively linked to the balance detection module, wherein the alert unit is activated by the balance detection module for generating an alert signal when the balance detection module detects a suspicious movement of the movable object.

### BACKGROUND OF THE PRESENT INVENTION

1. Field of Invention

The present invention relates to an alarm system, and more particular to a balance alarm sensing arrangement and method thereof, wherein a movable object is secured by a balance detection module for preventing the movable object being intentionally moved.

2. Description of Related Arts

Lockable container, such as a safe or a secure lockable cabinet, is commonly used for securing valuable objects, such as jewelries and watches, against theft or damage or for securing firearms, such as guns, to prevent access to unauthorized persons. A lockable container generally comprises a locking arrangement for releasably locking up the safe, cabinet or other container, wherein the locking arrangement can be a mechanical or electronic fastening device and can be released by an object such as key, keypad, or fingerprint.

For example, the locking arrangement is embodied as a key slot formed at the container, wherein a corresponding key is inserted into the key slot to unlock the container.

For another example, the locking arrangement is embodied as a numerical lock comprising a keypad, wherein the user must enter a sequence of numbers in order to open the lock. If the key strength is set at lower level, the safe can be unlocked by figuring out a numerical puzzle. If the key strength is set at higher level, the user may forget the sequence of numbers. In case of emergency, the user will take longer time to unlock the container so as to gain access thereof.

A biometric lock generally comprises a recognizing means for identification, wherein the biometric lock takes advantage of technologies such as fingerprint scanning to authenticate the user to access the container.

The containers with the above mentioned locking arrangements have a common drawback that the container, such as a portable safe, can be moved intentionally from one place to another place. In other words, a thief can steal the movable container and break the locking arrangement later. In addition, there is no additional security device adapted to add-on to the container in order to provide an additional security.

### SUMMARY OF THE PRESENT INVENTION

The invention is advantageous in that it provides a balance alarm sensing arrangement, wherein the movable object is secured by a balance detection module for preventing the movable object being intentionally moved.

Another advantage of the invention is to a balance alarm sensing arrangement, wherein the balance detection module is activated with a predetermined time delay for enabling false alarm of the movable object.

Another advantage of the invention is to a balance alarm sensing arrangement, wherein the balance detection module is adapted to automatically detect and set the orientation as an initial setting for incorporating with different types of movable objects.

Another advantage of the invention is to a balance alarm sensing arrangement, wherein the balance detection module can be deactivated by a biometric sensor such that the movable object is accessed after verifying a fingerprint of a user.

Another advantage of the invention is to a balance alarm sensing arrangement, wherein the balance alarm sensing arrangement is adapted for incorporating with any movable object having a rigid surface, such as a cabinet door, computer or window to provide an additional security of the movable object.

Another advantage of the invention is to a balance alarm sensing arrangement, wherein the configuration of the movable object is relatively simplified so that the set up of the present invention is simple and easy.

Another advantage of the invention is to a balance alarm sensing arrangement, which does not involve complicated or expensive mechanical components so as to minimize the manufacturing cost of the present invention.

Another advantage of the invention is to provide a balance alarm sensing arrangement, wherein no expensive or complicated structure is required to employ in the present invention in order to achieve the above mentioned objects. Therefore, the present invention successfully provides an economic and efficient solution for preventing any unwanted access of the movable object and for alerting the user to a specific danger.

Additional advantages and features of the invention will become apparent from the description which follows, and may be realized by means of the instrumentalities and combinations particular point out in the appended claims.

According to the present invention, the foregoing and other objects and advantages are attained by a balance alarm sensing arrangement for a movable object having a rigid surface, wherein the balance alarm sensing arrangement comprises:

a balance detection module, which is arranged for being supported at the rigid surface of the movable object for detecting a stability of the movable object;

a deactivating unit for deactivating the balance detection module; wherein the balance detection module is deactivated to allow the movable object being moved; and

an alert unit operatively linked to the balance detection module, wherein the alert unit is activated by the balance detection module for generating an alert signal when the balance detection module detects a suspicious movement of the movable object.

In accordance with another aspect of the invention, the present invention comprises a method of monitoring a movable object having a rigid surface by a balance alarm sensing arrangement, comprising the following steps.

Detect a stability of the movable object by a balance detection module of the balance alarm sensing arrangement which is supported at the rigid surface of the movable object.

Generate an alert signal by an alert unit of the balance alarm sensing arrangement when the balance detection module detects a suspicious movement of the movable object.

Deactivate the balance detection module by a deactivating unit before the alert unit is activated by the balance detection module to allow the movable object being moved.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a balance alarm sensing arrangement according to a first preferred embodiment of the present invention, illustrating the balance alarm sensing arrangement incorporating with a container having top accessing door.

FIG. 2 is a sectional view of the balance alarm sensing arrangement according to the above first preferred embodiment of the present invention.

FIG. 3 is a block diagram of the balance alarm sensing arrangement according to the above first preferred embodiment of the present invention.

FIG. 4 is a perspective view of a balance alarm sensing arrangement according to a second preferred embodiment of the present invention illustrating the balance alarm sensing arrangement incorporating with a container having front accessing door.

FIG. 5 is a perspective view of a balance alarm sensing arrangement according to a third preferred embodiment of the present invention, illustrating the balance alarm sensing arrangement incorporating with a computer.

FIG. 6 is a perspective view of a balance alarm sensing arrangement according to a fourth preferred embodiment of the present invention, illustrating the balance alarm sensing arrangement incorporating with a hard-shell luggage.

FIG. 7 is a perspective view of a balance alarm sensing arrangement according to a fifth preferred embodiment of the present invention illustrating the balance alarm sensing arrangement incorporating with a window.

### DETAILED DESCRIPTION OF THE PREFERRED EMBODIMENT

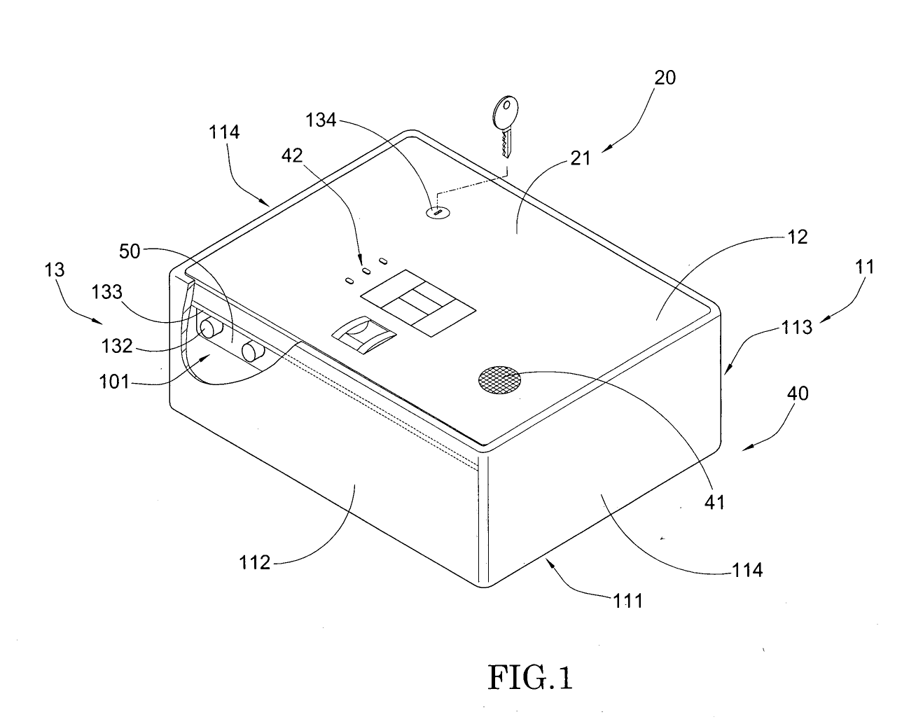

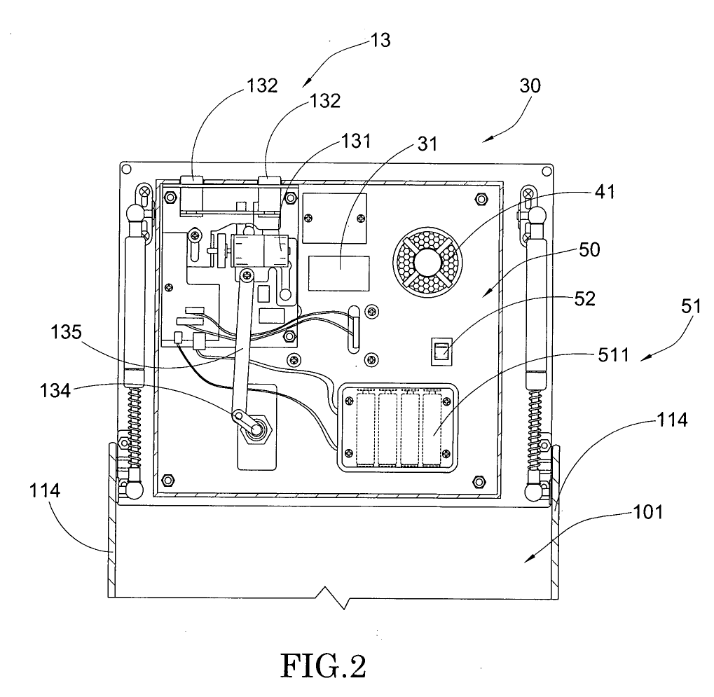

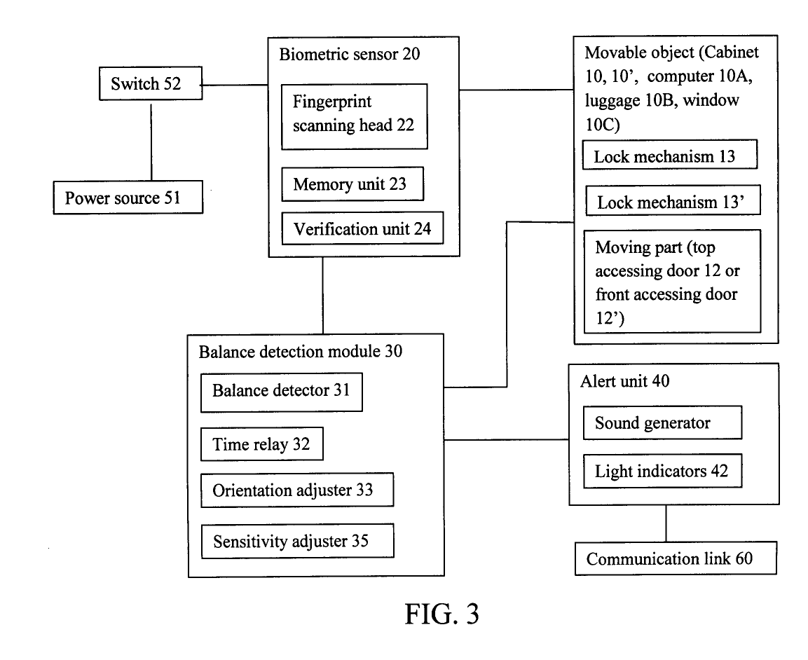

Referring to FIGS. 1 to 3 of the drawings, a balance alarm sensing arrangement according to a first preferred embodiment of the present invention is illustrated, wherein the balance alarm sensing arrangement is adapted for incorporating with a movable object. In particular, the balance alarm sensing arrangement is adapted for providing at a rigid surface of the movable object. According to the first embodiment, the movable object is embodied as a container 10, such as a portable safe, and the balance alarm sensing arrangement is embodied as to be built-in with the container 10, wherein the accessing door of the container 10 is the rigid surface of the movable object. It should be noted that the movable object can also be other moveable and valuable object such as an electronic item likes tablet, phone and notebook, a firearm, and the like.

The container 10, according to the first embodiment, is a box shaped container, and comprises a box body 11 having a compartment 101 with a top opening, and a top accessing door 12 hinged with the box body 11. The box body 11 comprises a bottom panel 111, a front panel 112, a rear panel 113, and two side panels 114 to define the compartment 101 within the bottom panel 111, the front panel 112, the rear panel 113, and the side panels 114.

In addition, the container 10 is arranged to move between a closed position that the compartment 101 of the container 10 is enclosed and an opened position that the container 10 is enabled for being accessed to the compartment 101. In particular, the container 10 has a movable part being moved between the opened and closed positions. It is appreciated that the container 10 can also be considered as the movable part that the container 10 can be moved from one place to another place. According to the first embodiment, the top accessing door 12, as the movable part, is pivotally hinged with the box body 11, wherein a rear edge of the top accessing door 12 is pivotally connected to the rear panel 113 such that the top accessing door 12 is adapted to pivotally fold between the opened position and the closed position. At the opened position, the top accessing door 12 is upwardly and pivotally folded to expose the compartment 101. At the closed position, the top accessing door 12 is downwardly and pivotally folded at the top opening of the box body 11 to enclose the compartment 101 thereof.

Accordingly, the container 10 further comprises a lock mechanism 13 being actuated to lock up the container 10 at the closed position and to unlock the container 10 for enabling the container 10 to move at the opened position. In other words, the lock mechanism 13 is arranged to lock up the top accessing door 12 with the box body 11 and to unlock the top accessing door 12 with the box body 11 for enabling the top accessing door 12 being upwardly folded.

In particular, the lock mechanism 13 is provided at the top accessing door 12 to releasably lock up the top accessing door 12 at the closed position, wherein the lock mechanism 20 is actuated to release the top accessing door 12 such that the top accessing door 12 can be folded from the closed position to the opened position.

The lock mechanism 13 comprises a power generator 131 and at least a locking latch 132 driven by the power generator 131 to lock up the top accessing door 12 at the front panel 112 of the box body 11. The power generator 131 is embodied as an electric motor, wherein the power generator 131 comprises a driving shaft operatively connected to the locking latch 132 to drive the locking latch 132 moving to lock and unlock the top accessing door 12.

Preferably, two locking latches 132 are actuated by the power generator 131 synchronically. When the locking latches 132 are moved at a locked position, the head portions of the locking latches 23 are extended at the same time to engage with the front panel 112 of the box body 11. The locking mechanism 13 further comprises a locking member 133 provided at the inner surface of the front panel 112 of the box body 11 to engage with the head portions of the locking latches 132.

The locking member 133 is embodied as an elongated locking bar coupled at the inner surface of the front panel 112 of the box body 11 such that when the locking latches 132 are actuated toward the front panel 112, the head portions of the locking latches 132 are extended at the same time to engage with the locking member 133 at the front panel 112 of the box body 11. It is appreciated that the locking member 133 can be embodied as two socket members coupled at the inner surface of the front panel 112 of the box body 11 such that the head portions of the locking latches 132 are alignedly extended to engage with the sockets of the socket members respectively.

The lock mechanism 13 further comprises a key lock assembly for releasing the top accessing door 12, wherein the key lock assembly has a key slot 134 formed on the top surface of the top accessing door 12 and a key actuation unit 135 operatively linked to the locking latches 132 in such a manner that when a corresponding key is inserted into the key slot 134, the key is adapted to actuate the key actuation unit 135 to move the locking latches 132 between the locked position and the unlocked position. In other words, the power generator 131 can be overwritten by the key lock assembly such that the user is able to unlock the top accessing door 12 in case the fingerprint scanning mechanism 20 is not working properly. Preferably, a key slot cover is detachably coupled on the top surface of the top accessing door 12 to cover the key slot 134 thereon.

The balance alarm sensing arrangement comprises a balance detection module 30 for detecting a stability of the movable object, i.e. the container 10, an alert unit 40 for generating an alert signal, and means for deactivating the balance detection module 30. According to the preferred embodiment, the deactivating means comprises a biometric sensor 20 for fingerprint scanning to deactivate the balance detection module 30.

The balance alarm sensing arrangement further comprises a protection housing 50 and a power source 51 received in the protection housing 50, wherein the biometric sensor 20, the balance detection module 30, and the alert unit 40 are housed in the protection housing 50 and are electrically linked to the power source 51. Preferably, the protection housing 50 is coupled with the bottom side of the top accessing door 12 of the container 10. In addition, a switch 52 is placed within the protection housing 50 to operatively link with the power source 51 to disable the balance alarm sensing arrangement once the protection housing 50 is opened. Therefore, it is always an option for the user to enable or disable the balance alarm sensing arrangement once the container 10 is unlocked.

The power source 51 is activated in responsive to the biometric sensor 20. The power source 51 comprises a battery compartment 511 supported in the protection housing 50 and a compartment cover detachably covering the battery compartment 511.

It is worth mentioning that the compartment cover can be detached from the protection housing 50 for replacing batteries in the battery compartment 511 when the top accessing door 12 is folded at the opened position. In other words, when the top accessing door 12 is folded and locked at the closed position, the power source 51 cannot be accessed.

In addition, the power generator 131 of the lock mechanism 13 is operatively linked to the power source 51, such that the power generator 131 is powered by the power source 51 to drive the locking latch 132 moving to lock and unlock the top accessing door 12.

Accordingly, the balance detection module 30 is operatively linked to the biometric sensor 20, wherein the balance detection module 30 is received in the protection housing 50 and is supported by the container 10. When a fingerprint of a user is detected in an authorized manner, the balance detection module 30 is deactivated to allow the container 10 moving between the closed and opened positions.

It is appreciated that the biometric sensor 20 can replaced by a keypad that when a corrected sequence of keys is input by the user, the balance detection module 30 is deactivated to allow the container 10 moving between the closed and opened positions.

The alert unit 40 is operatively linked to the balance detection module 30, wherein the alert unit is activated by the balance detection module for generating the alert signal when the balance detection module detects a suspicious movement of the container 10.

According to the preferred embodiment, the biometric sensor 20 comprises a transparent scanning window 21 formed on the top surface of the top accessing door 12, wherein the finger of the user aligns with the transparent scanning window 21 for being scanned.

The biometric sensor 20 further comprises a fingerprint scanning head 22 supported by the container 10 to align with the transparent scanning window 21 such that when the finger of the user places on the transparent scanning window 21, the fingerprint scanning head 22 is adapted to scan the fingerprint of the user and to transmit the fingerprint image as a digit data.

The biometric sensor 20 further comprises a memory unit 23 protected within the protection housing 50 for storing a fingerprint of one or more authorized users in a digital format and a verification unit 24 operatively linked to the memory unit 23 for actuating the lock mechanism 14 to unlock the top accessing door 12 upon the fingerprint scanned at the transparent scanning window 21 matching with the fingerprint of one or more authorized users stored in the memory unit 23.

Accordingly, the user is able to store multiple fingerprints data in the memory unit 23 such that more than one authorized users can be access and unlock the lock mechanism 14. Or, multiple fingerprints data in the memory unit 23 can be set by different fingers of the user such that the user is able to use one of the fingers for scanning.

The verification unit 24 comprises a verification circuit protected within the protection housing 50, wherein the verification circuit of the verification unit 24 is operatively linked between the fingerprint scanning head 22 and the memory unit 23. When the verification unit 24 receives the fingerprint image from the fingerprint scanning head 22, the verification unit 24 will compare the fingerprint image and the stored fingerprint date from the memory unit 23. When the fingerprint image matches the stored fingerprint date, the verification unit 24 will send an actuation signal to the lock mechanism 14. It is worth mentioning that the verification unit 24 forms a control unit to activate the lock mechanism 14 by means of the authorized fingerprint scanning.

The balance detection module 30 comprises a balance detector 31 detecting the movement of the top accessing door 12 and the container 10, wherein the alert unit 40 is automatically activated when the balance detector 31 detects a suspicious movement of the container 10. Accordingly, the balance detector 31 will detect whether the movable object at an unbalance status, i.e. the movement thereof. Therefore, once the container 10 loses its balance due to, for example, any movement of it, even though a slightly movement, the alert unit 40 will be activated automatically. It is worth mentioning that in order to maintain the movable object at the balance status, the movable object cannot be moved up-and-down, left-and-right, front-and-back, or any tilted direction. Any movement of the movable object, i.e. the top accessing door 12 and/or the container 10, will cause the unbalance of the movable object and will be detected by the balance detector 31.

The balance detection module 30 further comprises a sensitivity adjustor 35 operatively linked to the balance detector 31 to selectively adjust a balance sensitivity thereof. Accordingly, the user is able to selectively adjust the balance sensitivity of the balance detector 31 by the sensitivity adjustor 35 to set the acceptable movement of the movable object. For example, the user is able to adjust the balance sensitivity of the balance detector 31 for allowing the movable object being moved within 3 seconds. Therefore, when the balance detector 31 detects the movable object with a continuous movement for more than 3 seconds, the balance detector 31 will activate the alert unit 40. Likewise, the user is able to adjust the degree of acceptable movement of the movable object, wherein when the movable object is moved within the acceptable movement, such as slight displacement of the movable object, the balance detector 31 will consider as a false alarm. When the movable object is moved out of the acceptable movement range, the balance detector 31 will activate the alert unit 40. It is worth mentioning that the balance adjustor 35 can also be built in the balance detector 31 which can be a detector capable of adjusting its sensitivity so that the user is free to adjust its sensitivity of movement for various purposes and functions.

In other words, when the top accessing door 12 is moved from the closed position to the opened position without the authorized fingerprint, the balance detector 31 will also detects the motion of the top accessing door 12 of the container 10, such that the alert unit 40 will be automatically activated by the balance detection module 30. Likewise, when the container 10 is moved from one place to another place even though the top accessing door 12 is remained at the closed position, the balance detector 31 will also detects the motion of the container 10, such that the alert unit 40 will also be automatically activated by the balance detection module 30.

Preferably, the balance detector 31 is a gyro sensor, especially a 3-axis gyroscopic sensor, for measuring an orientation of the container 10. Therefore, the balance detector 31 will detect 3-dimensional movement of the container 10 including the top accessing door 12. It is worth mentioning that the balance detector 31 is automatically deactivated when the biometric sensor 20 detects the fingerprint in an authorized manner. In other words, once the balance detector 31 is deactivated, the alert unit 40 will also be automatically deactivated.

Alternatively, the balance detector 31 can be an inertial measurement unit (IMU) that measures and reports on the orientation of the movable object, i.e. the container 10. It is appreciated that any balance detector can be incorporated in the present invention that can measure and set the initial orientation of the movable object and detect any movement of the movable object in responsive to the initial orientation of the movable object.

The balance detection module 30 further comprises a time relay 32 operatively linked to the alert unit 40 to delay an activation time of the alert unit 40 for providing sufficient time for the user to deactivate the balance detection module 30 before the alert unit 40 is activated to generate the alert signal.

Accordingly, when the container 10 is moved from one place to another place by the user, such as from the drawer to the desktop, the balance detector 31 will detect the movement of the container 10 as the suspicious movement thereof It is worth mentioning that the container 10 itself can be considered as the movable object while the top accessing door 12 of the container 10 can also be considered as the movable object. The time relay 32 will delay the activation of the balance detection module 30, such as a time range from 5 seconds to 30 seconds, before the alert unit 40 is activated by the balance detection module 30. Therefore, the user will have sufficient time to place the finger at the transparent scanning window 21 for fingerprint verification. Once the biometric sensor 20 detects the fingerprint in an authorized manner with the time range, the balance detection module 30 will be automatically deactivated. If the fingerprint is scanned and verified as an unauthorized manner or no fingerprint is scanned by the biometric sensor 20 within the time range, the alert unit 40 is automatically activated by the balance detection module 30.

It is worth mentioning that when the biometric sensor 20 detects the fingerprint in an authorized manner, the lock mechanism 13 is automatically actuated to unlock the container 10. At the same time, the balance detection module 30 will be automatically deactivated. Therefore, the user is able to open the top accessing door 12. Once the user close the top accessing door 12, the biometric sensor 20 will scan and receive the fingerprint, wherein the lock mechanism 13 is automatically actuated to lock the container 10. At the same time, the balance detection module 30 will be automatically activated.

Accordingly, the balance detection module 30 comprises an orientation adjuster 33 supported within the protection housing 50 for detecting an initial orientation of the container 10. Therefore, the alert unit 40 is activated by the balance detection module 30 when the balance detection module 30 detects a suspicious movement of the container 10 in responsive to the initial orientation thereof According to the first embodiment, the balance alarm sensing arrangement is built-in with the container 10 and is supported at the top accessing door 12 thereof. Therefore, the orientation adjuster 33 will detect the initial orientation of the top accessing door 12 at the horizontal orientation.

The alert unit 40 comprises a sound generator 41 received within the protection housing 50 for generating sound signal as the alert signal. Accordingly, the sound generator 41 has volume and tone adjustment for the user to adjust the volume of the alert signal and to select the tone of the alert signal.

The alert unit 40 further comprises one or more light indicators 42 provided on the top accessing door 12 of the container 10 for indicating the status of the balance alarm sensing arrangement. Accordingly, the light indicators 42 are preferably LED lights electrically linked to the power source 51 and the balance detection module 30, wherein one of the light indicators 42 is arranged for indicating the power status of the power source 51, such as low battery indication. Two of the light indicators 42 are arranged for indicating the statuses of the balance alarm sensing arrangement, such as armed indication and disarmed indication. For example, when the respective light indicator 42 generates a red light, the balance alarm sensing arrangement is indicated as armed status.

When the respective light indicator 42 generates a green light, the balance alarm sensing arrangement is indicated as disarmed status.

The balance alarm sensing arrangement further comprises a communication link 60 operatively linked to the alert unit 40 for generating a notification to a designated communication device. The communication link 60 can be a phone port connecting to a phone line in such a manner that when the alert unit 40 is activated, the communication link 60 is automatically activated to make a phone message to a designated phone number. The communication link 60 can be an Internet port connecting to Internet in such a manner that when the alert unit 40 is activated, the communication link 50 is automatically activated to send message to a designated Internet-enabled device. Likewise, the communication link 60 can be a “WiFi” transmitter wirelessly connecting to a “WiFi” enabled device in such a manner that when the alert unit 40 is activated, the communication link 60 is automatically activated to send a message to the “WiFi” enabled device. The communication link 60 can also be arranged to communicate via cell phone system to send alert signal to the user's cell phone or desk phone when the alert unit 40 is activated.

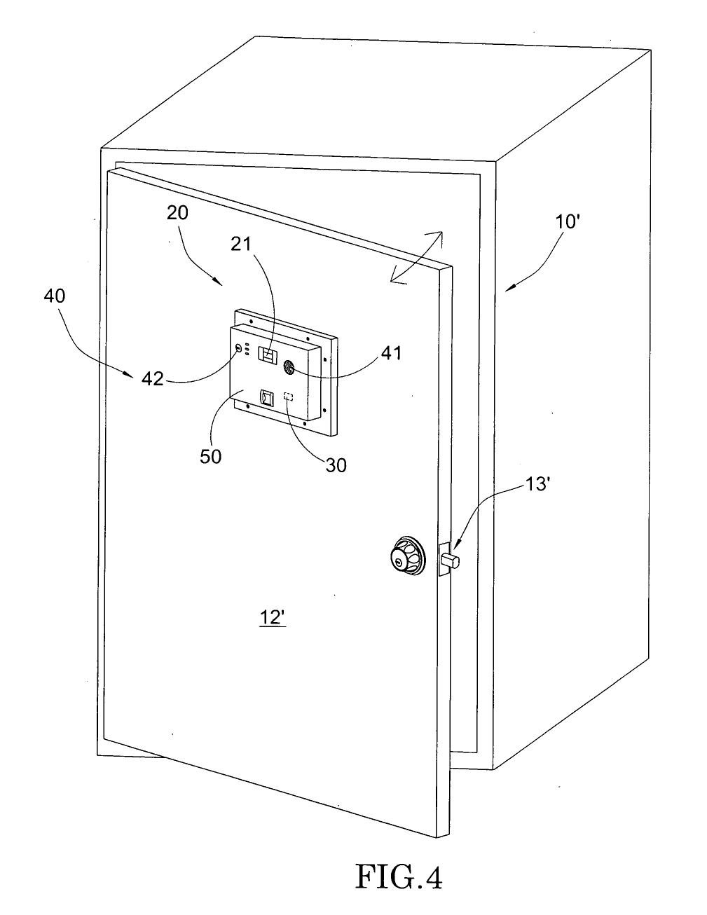

As shown in FIG. 4, the balance alarm sensing arrangement of the second embodiment illustrates an alternative mode of the first embodiment, wherein the balance alarm sensing arrangement is externally coupled with the container 10′. Accordingly, the container 10′ can be embodied as a computer case, bookshelf, drawer, doors, or storage container. According to the second embodiment, the container 10′ is embodied as a drawer having a front accessing door 12′. In addition, the lock mechanism 13′ is provided at the front accessing door 12′ to lock/unlock the front accessing door 12′ with the container 10′.

The balance alarm sensing arrangement, having the same structural configuration of the first embodiment, is externally affixed to the front accessing door 12′ via screw, adhesive, or the like, wherein the protection housing 50′ is embodied as a hand-held casing to detachably affix to the front accessing door 12′. Accordingly, the biometric sensor 20, the balance detection module 30, and the alert unit 40 are housed in the protection housing 50′ and are electrically linked to the power source 51 within the protection housing 50′.

Another difference between the first and second embodiments is that the lock mechanism 13′ is not operatively actuated by the biometric sensor 20. In other words, the front accessing door 12′ can be locked/unlocked without any fingerprint verification.

Accordingly, when the front accessing door 12′ is moved between its opened and closed positions, such as opening the drawer, the balance detector 31 will detect the movement of the front accessing door 12′ as the suspicious movement thereof. The time relay 32 will delay the activation of the balance detection module 30 before the alert unit 40 is activated by the balance detection module 30. Therefore, the user will have sufficient time to place the finger at the transparent scanning window 21 for fingerprint verification. Once the biometric sensor 20 detects the fingerprint in an authorized manner with the time range, the balance detection module 30 will be automatically deactivated. If the fingerprint is scanned and verified as an unauthorized manner or no fingerprint is scanned by the biometric sensor 20 within the time range, the alert unit 40 is automatically activated by the balance detection module 30.

It is worth mentioning that the locking/unlocking operation of the lock mechanism 13′ is independent with the operation of the balance alarm sensing arrangement such that even though the lock mechanism 13′ can be broken, the balance alarm sensing arrangement will also be armed by detecting the motion of the front accessing door 12′.

The orientation adjuster 33 is supported at the front accessing door 12′ of the container 10′ such that the orientation adjuster 33 will detect the initial orientation of the front accessing door 12′ at the vertical orientation. Since the balance alarm sensing arrangement of the second embodiment can be selectively affixed to any surface, the orientation adjuster 33 will automatically detect an initial orientation of the surface. For example, when the balance alarm sensing arrangement is affixed to an inclined surface, the orientation adjuster 33 will automatically detect an initial orientation of the surface at an inclined orientation once the balance detection module 30 is activated. Therefore, the user is able to preset the initial orientation of the container 10′ through the orientation adjuster 33.

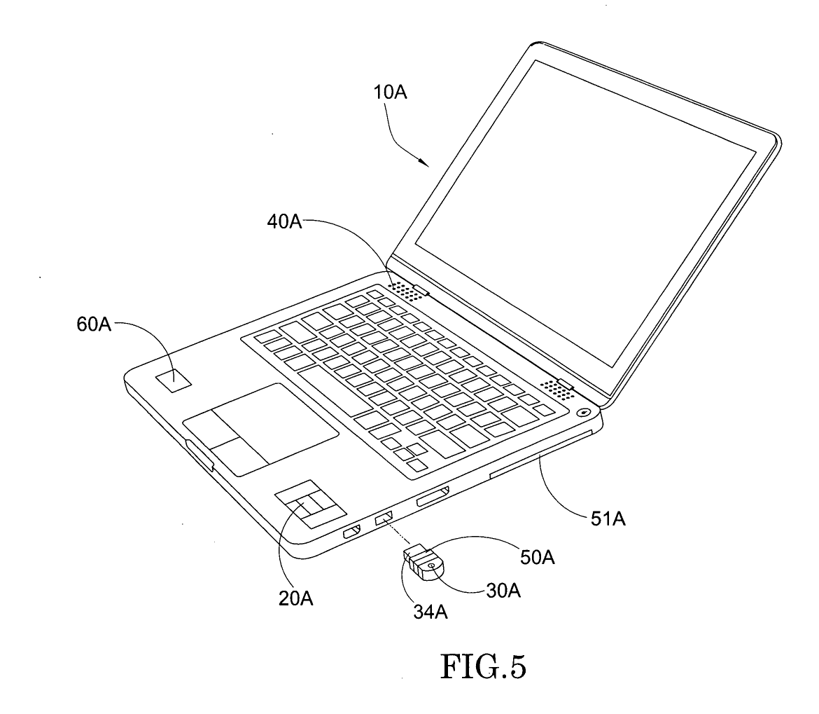

As shown in FIG. 5, the balance alarm sensing arrangement of the third embodiment illustrates an alternative mode of the first embodiment, wherein the balance alarm sensing arrangement is arranged to incorporate with a computer 10A as the movable object. Accordingly, the biometric sensor 20A, the alert unit 40A, the power source 51A, and the communication link 60A are built-in at the computer 10A, wherein the balance detection module 30A is housed in the protection housing 50A.

As shown in FIG. 5, the balance detection module 30A further comprises a connector 34A detachably coupled with a peripheral port of the computer 10A to electrically link the power source 51A with the balance detection module 30A so as to activate the balance detection module 30A. In other words, once the connector 34A is plugged into the peripheral port of the computer 10A, the balance detection module 30A will be automatically activated. Accordingly, the orientation adjuster 33 will automatically detect the initial orientation of the balance detector 31 i.e. the initial orientation of the computer 10A. Once the computer 10A is moved, the balance detector 31 will be activated. The time relay 32 will delay the activation of the alert unit 40 such that the user is able to deactivate the balance detection module 30 via the biometric sensor 20A or by inputting a passcode through the keyboard of the computer 10A. If the balance detection module 30 does not deactivate within the delayed time period, the alert unit 40A will be activated for generating the alert signal. It is worth mentioning that the user is able to selectively adjust the balance sensitivity of the balance detector 31 by the sensitivity adjustor 35 to set the acceptable movement of the computer.

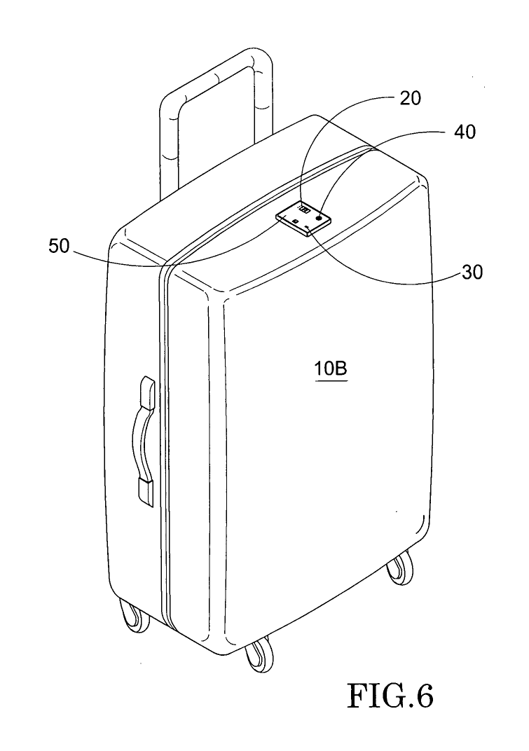

As shown in FIG. 6, the balance alarm sensing arrangement of the fourth embodiment illustrates an alternative mode of the first embodiment, wherein the balance alarm sensing arrangement is formed as a portable device to place on the rigid surface of the movable object. As shown in FIG. 6, the movable object is a luggage 10B to define the rigid surface as the top side of the luggage 10B. It is worth mentioning that when the balance alarm sensing arrangement is placed on the top surface of the luggage 10B, the balance detection module 30 can be activated to set the initial orientation of the luggage 10B via the orientation adjuster 33. Therefore, any motion of the luggage 10B will trigger the balance detector 31 to activate the alert unit 40. It is worth mentioning that the user is able to selectively adjust the balance sensitivity of the balance detector 31 by the sensitivity adjustor 35 to set the acceptable movement of the luggage 10B.

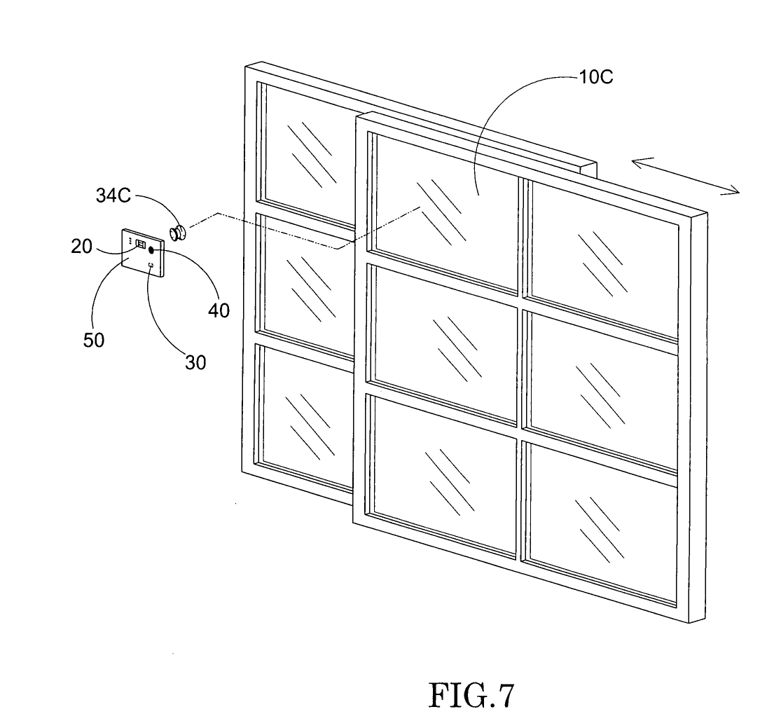

As shown in FIG. 7, the balance alarm sensing arrangement of the fifth embodiment illustrates an alternative mode of the first embodiment, wherein the balance alarm sensing arrangement is formed as a window alarm system to place on the rigid surface of the movable object.

As shown in FIG. 7, the movable object is a window 10C to define the rigid surface as the window surface 10C. Therefore, when the balance alarm sensing arrangement is detachably placed on the window surface 10C via a fastener such as a suction cup 34C, the balance detection module 30 can be activated to set the initial orientation of the window 10C via the orientation adjuster 33, wherein any motion of the window 10C will trigger the balance detector 31 to activate the alert unit 40. It is worth mentioning that the user is able to selectively adjust the balance sensitivity of the balance detector 31 by the sensitivity adjustor 35 to set the acceptable movement of the window.

It is appreciated that the purpose of the balance alarm sensing arrangement of the present invention is to notify the user in the vicinity that unauthorized movement of the movable object is occurring. The balance alarm sensing arrangement of the present invention can also be placed on the walls in the house and used as an earthquake alarm to notify unconscious people of an earthquake and to take appropriate action.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A balance alarm sensing arrangement for a movable object having a rigid surface, comprising:
a balance detection module, which is arranged for being supported at said rigid surface of said movable object to detect a stability of said movable object;
means for deactivating said balance detection module; wherein said balance detection module is deactivated to allow said movable object being moved; and
an alert unit operatively linked to said balance detection module, wherein said alert unit is activated by said balance detection module for generating an alert signal when said balance detection module detects a suspicious movement of said movable object.

2. The balance alarm sensing arrangement, as recited in claim 1, wherein said balance detection module comprises a time relay operatively linked to said alert unit to delay an activation time of said alert unit for providing sufficient time to deactivate said balance detection module before said alert unit is activated to generate said alert signal.

3. The balance alarm sensing arrangement, as recited in claim 1, wherein said balance detection module comprises a balance detector arranged for being supported at said rigid surface of said movable object for measuring a movement of said object and being automatically deactivated by said deactivating means, wherein said alert unit is automatically activated when said balance detector detects a suspicious movement of said object.

4. The balance alarm sensing arrangement, as recited in claim 2, wherein said balance detection module comprises a balance detector arranged for being supported at said rigid surface of said movable object for measuring a movement of said object and being automatically deactivated by said deactivating means, wherein said alert unit is automatically activated when said balance detector detects a suspicious movement of said object.

5. The balance alarm sensing arrangement, as recited in claim 1, wherein said balance detection module comprises an orientation adjuster arranged for being supported at said rigid surface of said movable object, wherein said orientation adjuster is activated for automatically detecting an initial orientation of said movable object once said balance detection module is activated, such that said alert unit is activated by said balance detection module when said balance detection module detects a suspicious movement of said movable object in responsive to said initial orientation thereof.

6. The balance alarm sensing arrangement, as recited in claim 2, wherein said balance detection module comprises an orientation adjuster arranged for being supported at said rigid surface of said movable object, wherein said orientation adjuster is activated for detecting an initial orientation of said movable object once said balance detection module is activated, such that said alert unit is activated by said balance detection module when said balance detection module detects a suspicious movement of said movable object in responsive to said initial orientation thereof

7. The balance alarm sensing arrangement, as recited in claim 4, wherein said balance detection module comprises an orientation adjuster arranged for being supported at said rigid surface of said movable object, wherein said orientation adjuster is activated for detecting an initial orientation of said movable object once said balance detection module is activated, such that said alert unit is activated by said balance detection module when said balance detection module detects a suspicious movement of said movable object in responsive to said initial orientation thereof

8. The balance alarm sensing arrangement, as recited in claim 1, wherein said deactivating means comprises a biometric sensor operatively linked said balance detection module and arranged in such a manner that when a fingerprint of a user is detected in an authorized manner, said balance detection module is deactivated to allow said movable object being moved.

9. The balance alarm sensing arrangement, as recited in claim 4, wherein said deactivating means comprises a biometric sensor operatively linked said balance detection module and arranged in such a manner that when a fingerprint of a user is detected in an authorized manner, said balance detection module is deactivated to allow said movable object being moved.

10. The balance alarm sensing arrangement, as recited in claim 7, wherein said deactivating means comprises a biometric sensor operatively linked said balance detection module and arranged in such a manner that when a fingerprint of a user is detected in an authorized manner, said balance detection module is deactivated to allow said movable object being moved.

11. The balance alarm sensing arrangement, as recited in claim 1, further comprising a protection housing adapted for being placed at said rigid surface of said movable object, wherein said balance detection module, said deactivating means, and said alert unit are received in the protection housing.

12. The balance alarm sensing arrangement, as recited in claim 4, further comprising a protection housing adapted for being placed at said rigid surface of said movable object, wherein said balance detection module, said deactivating means, and said alert unit are received in the protection housing.

13. The balance alarm sensing arrangement, as recited in claim 10, further comprising a protection housing adapted for being placed at said rigid surface of said movable object, wherein said balance detection module, said deactivating means, and said alert unit are received in the protection housing.

14. The balance alarm sensing arrangement, as recited in claim 1, further comprising a lock mechanism for releasably locking up said movable object, wherein said deactivating means further comprises means for actuating said lock mechanism when said balance detection module is deactivated.

15. The balance alarm sensing arrangement, as recited in claim 10, further comprising a lock mechanism for releasably locking up said movable object, wherein said deactivating means further comprises means for actuating said lock mechanism when said balance detection module is deactivated.

16. The balance alarm sensing arrangement, as recited in claim 13, further comprising a lock mechanism for releasably locking up said movable object, wherein said deactivating means further comprises means for actuating said lock mechanism when said balance detection module is deactivated.

17. A method of monitoring a movable object having a rigid surface by a balance alarm sensing arrangement, comprising the steps of:
(a) detecting a stability of said movable object by a balance detection module of said balance alarm sensing arrangement which is supported at said rigid surface of said movable object;
(b) generating an alert signal by an alert unit of said balance alarm sensing arrangement when said balance detection module detects a suspicious movement of said movable object; and
(c) deactivating said balance detection module by a deactivating unit before said alert unit is activated by said balance detection module to allow said movable object being moved.

18. The method, as recited in claim 17, wherein the step (b) further comprises a step of delaying an activation time of said alert unit for providing sufficient time to deactivate said balance detection module before said alert unit is activated to generate said alert signal.

19. The method, as recited in claim 17, wherein the step (a) further comprises a step of automatically detecting an initial orientation of said movable object by an orientation adjuster being supported at said rigid surface of said movable object once said balance detection module is activated.

20. The method, as recited in claim 18, wherein the step (a) further comprises a step of automatically detecting an initial orientation of said movable object by an orientation adjuster being supported at said rigid surface of said movable object once said balance detection module is activated.

21. The method, as recited in claim 17, wherein said deactivating unit comprises a biometric sensor operatively linked said balance detection module, wherein the step (c) further comprises a step of detecting a fingerprint of a user in an authorized manner by said biometric sensor to deactivate said balance detection module so as to allow said movable object being moved.

22. The method, as recited in claim 20, wherein said deactivating unit comprises a biometric sensor operatively linked said balance detection module, wherein the step (c) further comprises a step of detecting a fingerprint of a user in an authorized manner by said biometric sensor to deactivate said balance detection module so as to allow said movable object being moved.

23. The method, as recited in claim 17, further comprising a step of receiving said balance detection module, said deactivating unit, and said alert unit in a protection housing, wherein said protection housing is placed at said rigid surface of said movable object.

24. The method, as recited in claim 22, further comprising a step of receiving said balance detection module, said deactivating unit, and said alert unit in a protection housing, wherein said protection housing is placed at said rigid surface of said movable object.

25. The method, as recited in claim 17, wherein the step (c) further comprises a step of actuating a locking mechanism to unlock said movable object by said deactivating unit when said balance detection module is deactivated.

26. The method, as recited in claim 24, wherein the step (c) further comprises a step of actuating a locking mechanism to unlock said movable object by said deactivating unit when said balance detection module is deactivated.
